(19) United States
(12) Patent Application Publication
(10) Pub. No.: US 2008/0196539 A1
(43) Pub. Date: Aug. 21, 2008

(54) Lever arrangement and operating unit for handlebar-steered vehicles

(75) Inventor: Werner Schmauder, Huelben (DE)

Correspondence Address: Lipsitz & McAllister, LLC, 755 MAIN STREET, MONROE, CT, 06468, US

(73) Assignee: Gustav Magenwirth GmbH & Co. KG, Bad Urach (DE)

(21) Appl. No.: 12/069,448

(22) Filed: Feb. 7, 2008

Related U.S. Application Data
(63) Continuation of application No. PCT/EP2006/007822, filed on Aug. 8, 2006.

(30) Foreign Application Priority Data
Aug. 10, 2005 (DE) 10 2005 039 109.5

(51) Int. Cl. G05G 1/04

(52) U.S. Cl. 74/519

(57) ABSTRACT

In order to improve a lever arrangement for handlebar-steered vehicles, comprising an actuating-lever housing which can be fitted to a handlebar, adjoining a handle, by way of a mounting portion and on which an actuating lever is mounted such that it can be pivoted about an axis, and comprising an adjusting lever which can be moved, by pivoting about a pivot axis, from a stable inactive position, in which the adjusting lever is positioned on that side of its pivot axis which is directed away from the actuating lever, into a stable active position, in which the adjusting lever is positioned on that side of its pivot axis which is directed toward the actuating lever, and vice versa, such that the adjusting lever can be moved out of the active position by straightforward manual actuation, it is proposed that the adjusting lever is mounted in a pivotable manner in an adjusting-lever housing, and in that the adjusting lever, in the active position, has a finger-actuating surface which is at a distance from the handle and is directed toward the latter and, when this finger-actuating surface is acted on, the adjusting lever executes a pivoting movement leading away from the handle and out of the active position.

This application is a continuation of International application No. PCT/EP2006/007822 filed on Aug. 8, 2006.

This patent application claims the benefit of International application No. PCT/EP2006/007822 of Aug. 8, 2006 and German application No. 10 2005 039 109.5 of Aug. 10, 2005, the teachings and disclosure of which are hereby incorporated in their entirety by reference thereto.

### BACKGROUND OF THE INVENTION

The invention relates to a lever arrangement for handlebar-steered vehicles, comprising an actuating-lever housing which can be fitted to a handlebar, adjoining a handle, by way of a mounting portion and on which an actuating lever is mounted such that it can be pivoted about an axis, and also comprising an adjusting lever which can be moved, by pivoting about a pivot axis, from a stable inactive position, in which the adjusting lever is positioned on that side of its pivot axis which is directed away from the actuating lever, into a stable active position, in which the adjusting lever is positioned on that side of its pivot axis which is directed toward the actuating lever, and vice versa.

Such a lever arrangement is known, for example, from U.S. Pat. No. 5,857,385, in which the adjusting lever, in its active position, rests on the handle and blocks access to the handle and associated actuation of the actuating lever.

In the case of this solution, movement of the adjusting lever out of the active position requires laborious manual actuation, in particular even using a hand which is not usually associated with this lever arrangement.

Furthermore, JP 2004-276649 A discloses a lever arrangement in which the adjusting lever is formed, and disposed, so as even to preclude direct manual release of the same in the active position.

It is therefore an object of the invention to improve a lever arrangement of the generic type such that the adjusting lever can be moved out of the active position by straightforward manual actuation.

### SUMMARY OF THE INVENTION

This object is achieved according to the invention, in the case of the lever arrangement of the type described in the introduction, in that the adjusting lever is mounted in a pivotable manner in an adjusting-lever housing disposed on the actuating-lever housing, and in that the adjusting lever, in the active position, has a finger-actuating surface which is at a distance from the handle and is directed toward the latter and, when this finger-actuating surface is acted on, the adjusting lever executes a pivoting movement leading away from the handle and out of the active position.

The advantage of the solution according to the invention can thus be seen in the fact that the adjusting lever can be moved out of the active position, and thus released, in a straightforward manner, for example by actuation by means of the thumb, which means that the adjusting lever, in its active position, has its finger-actuating surface spaced apart from the handle, albeit directed toward the latter, and can be moved away from the handle in order for the lever to be moved out of the active position.

An ergonomically advantageous design here provides that the adjusting lever, in the active position, is located outside a manual-action region for actuating the actuating lever, this region extending between a hand-resting surface of the handle and a hand-gripping surface of the actuating lever.

It is thus possible, for the purpose of moving the adjusting lever out of the active position, to position the hand both on the handle and on the actuating lever and to support it thereon in order to act on the finger-actuating surface of the adjusting lever.

It is particularly advantageous here if the adjusting lever, in the active position, has its finger-actuating surface disposed such that, when the fingers of one hand are engaged on the hand-gripping surface, this finger-actuating surface can be acted on by the thumb of the same hand, that is to say, with a hand positioned in this way, the finger-actuating surface is located in the region of action of the thumb of the same hand, this being based on an average hand size and thumb length and movement capability.

It is particularly advantageous in ergonomic terms if the adjusting lever, in the active position, is disposed such that as seen in the direction of the actuating-lever housing, starting from the hand-gripping surface, it has its finger-actuating surface located laterally alongside the hand-gripping surface of the actuating lever, albeit in particular spaced apart from a movement plane of the actuating lever.

It has proven to be particularly advantageous if the adjusting lever, in its active position, has its finger-actuating surface located approximately between the hand-griping surface of the actuating lever and the actuating-lever housing.

In order for it to be possible for the adjusting lever to be moved out of the active position in an ergonomically advantageous manner, an advantageous solution provides that the finger-actuating surface of the adjusting lever is located on that side of a movement plane of the actuating lever on which a hand which is acting on the actuating lever is located.

An expedient solution provides that the adjusting lever, both in the active position and in the inactive position, is located on that side of the movement plane on which the hand which is acting on the actuating lever is located.

As an alternative, or in addition, to the exemplary embodiments which have been described thus far, an advantageous embodiment provides that the adjusting lever can be moved in a pivoting plane which runs at an angle of less than 30° in relation to a movement plane of the actuating lever.

It is even more advantageous if the angle is less than 20°, and even better less than 15°.

The arrangement of the adjusting-lever housing relative to the actuating-lever housing has not been described any more specifically thus far. It would thus be conceivable, in principle, for the adjusting-lever housing to be screwed directly onto the actuating housing.

A solution which is expedient in terms of construction provides that the actuating-lever housing has a cover, on which the adjusting-lever housing is disposed.

It is even more advantageous if the adjusting-lever housing is formed integrally on the cover of the actuating-lever housing.

In particular when a hydraulic actuation transmission unit, on which the actuating lever acts, is provided, an expedient exemplary embodiment provides that the cover of the actuating-lever housing covers a hydraulic reservoir provided therein.

The functioning of the adjusting lever itself has not been described any more specifically thus far. An advantageous solution therefore provides that the adjusting lever acts on a transmission device which is biased elastically in a retraction direction.

The transmission device is preferably formed here such that it acts on the adjusting lever such that the latter passes automatically into the inactive position after moving out of the active position.

Various solutions are conceivable in order to make it possible for the adjusting lever to be secured in the active position. For example, it would be conceivable for the adjusting lever to be secured in a form-fitting or force-fitting manner.

A solution which is particularly straightforward in terms of construction provides that the adjusting lever, in the active position, is in an over-dead-center position and thus remains stable in the active position despite being subjected to the action of the transmission device.

In order for it to be possible for the over-dead-center position to be easily reached, it is preferably provided that, by means of the adjusting lever, an articulation of a pulling element of the transmission device can be moved over an arcuate segment about the pivot axis, and can thus be moved from the over-dead-center position, which corresponds to the active position, into the inactive position, which does not correspond to an over-dead-center position.

In order to achieve the situation where, in the case of such a constructional solution, only a small amount of space is required for the adjusting lever and the pulling element, it is preferably provided that the adjusting lever has two lever side pieces disposed on both sides of an interspace, and that the pulling element, leading away from the articulation, runs within the interspace.

The mounting of the adjusting lever has not been described any more specifically thus far. An advantageous solution here provides that the two lever side pieces are disposed between side walls of a housing portion of the adjusting-lever housing, so that the two lever side pieces are enclosed substantially by the housing portion of the adjusting-lever housing.

As far as pivotable mounting of the adjusting lever is concerned, an advantageous exemplary embodiment here provides that each lever side piece, on a side which is directed away from the interspace, is mounted in a pivotable manner on the respective side wall of the adjusting-lever housing.

Since the adjusting lever is accelerated in the direction of the inactive position, on account of the transmission device, when the active position is released, it is preferably provided that a damping element for the adjusting lever is associated with the inactive position, so that this damping element damps the striking action of the adjusting lever as it reaches the inactive position.

In addition to the lever arrangement which has been described thus far, the object mentioned in the introduction is also achieved according to the invention by an operating unit of a vehicle steered by a handlebar having at least one handle, a lever arrangement according to one of the preceding exemplary embodiments being associated with this operating unit.

Further features and advantages of the invention form the subject matter of the following description and of the illustration of an exemplary embodiment.

### BRIEF DESCRIPTION OF THE DRAWINGS

FIG. 1 shows a plan view of an exemplary embodiment of a lever arrangement according to the invention in conjunction with an operating unit according to the invention, the adjusting lever being in the active position;

FIG. 2 shows a section along line 2-2 in FIG. 1;

FIG. 3 shows a section along line 3-3 in FIG. 1;

FIG. 4 shows a section along line 4-4 in FIG. 2;

FIG. 5 shows a section similar to FIG. 4, but with the adjusting lever in the inactive position; and

FIG. 6 shows a section along line 6-6 in FIG. 1, but with the adjusting lever in the inactive position.

### DETAILED DESCRIPTION OF THE INVENTION

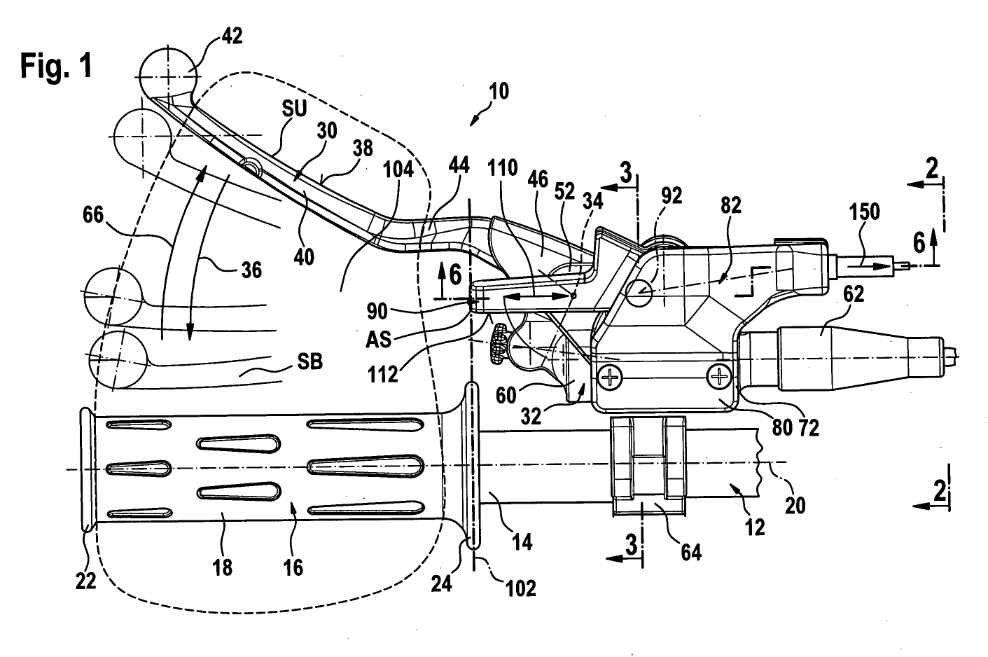

The exemplary embodiment illustrated in FIG. 1 of an operating unit 10 according to the invention for a handlebar-steered vehicle, in particular for a handlebar-steered motor vehicle, comprises a handlebar 12, which carries a handle 16 at an end region 14.

The handle 16 comprises, for its part, a hand-resting surface 18 which is located between an outer annular body 22, which projects above the hand-resting surface 18 in a radial direction in relation to a center axis 20, and an inner annular body 24, which projects above the hand-resting surface 18 likewise in a radial direction in relation to the center axis 20.

Also associated with the handle 16 is an actuating lever 30 which is mounted on an actuating-lever housing 32 such that it can be pivoted about an axis 34, and thereby it can be pivoted in an actuating direction 36 from a non-actuated position SU, depicted by solid lines in FIG. 1, and thus into an actuated position SB, in which the actuating lever 30 is closer to the handle 16 than in the non-actuated position.

For this purpose, the actuating lever 30 is preferably provided with a hand-gripping surface 38 which extends along an actuating portion 40 of the actuating lever 30 largely on that side of the actuating lever 30 which is directed away from the handle 16, the actuating portion being located between an outer, preferably ball-like boundary body 42 and an angled portion 44 of the actuating lever 30, and the angled portion 44 merging into a bearing portion 46 of the actuating lever, which bearing portion is mounted in the actuating-lever housing 32 such that it can be pivoted about the axis 34.

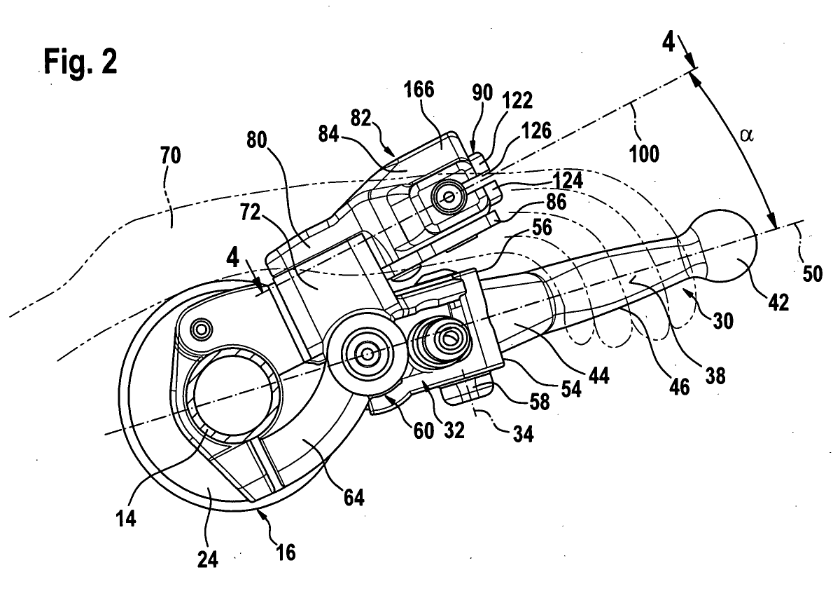

As is illustrated in FIG. 2, it is possible here for the actuating lever 30, as it pivots about the axis 34, to be moved in a movement plane 50 which preferably runs through the center axis 20 of the handle 16.

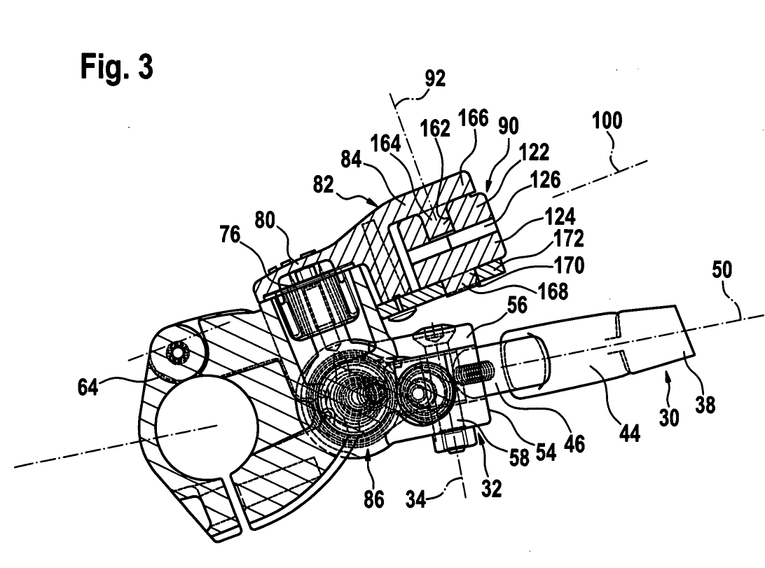

The actuating-lever housing 32, for its part, comprises, as is illustrated in FIGS. 2 and 3, a housing portion 52 with two bearing side pieces 54 and 56, between which the actuating lever 30 is disposed by way of its bearing portion 46, a bearing pin 58 passing through the bearing portion 46 and the two bearing side pieces 54 and 56 and allowing movement about the axis 34.

Furthermore, the actuating-lever housing 32 comprises a housing portion 60, in which there is disposed an actuation transmission unit (not illustrated specifically in the drawing), for example in the form of a known hydraulic actuating cylinder, by means of which, via a hydraulic connection 62, as is illustrated in FIG. 1, hydraulic actuation of a drive function of the handlebar-steered motor vehicle is possible.

This drive function may be, for example, a brake or a clutch or some other function for controlling driving functions of the handlebar-steered motor vehicle.

Fixing of the actuating-lever housing 32 is effected at the end region 14 of the handlebar 12 preferably via a clamping portion 64 of the actuating-lever housing 32, it being possible for this clamping portion to be fixed for example at the end region 14 of the handlebar 12 in a force-fitting manner, for example by being clamped firmly in place.

The actuating lever 30 preferably interacts with the actuation transmission unit such that, in the non-actuated position SU, there is no actuation of any driving function of the motor vehicle, whereas, in the actuated position SB of the actuating lever 30, a driving function of the motor vehicle is actuated, for example such that, in the case of a brake to be actuated, the brake is active or, in the case of a clutch to be actuated, the clutch is disengaged.

In all cases, however, the actuating lever 30 is always acted on counter to the actuating direction 36, in an actuation-release direction 66, and thus tends to pass into its non-actuated position SU from its actuated position SB if the hand-gripping surface 38 is not forced in the actuating direction 36 by a hand 70, which, when the vehicle is being driven, can be positioned both on the hand-resting surface 18 and on the hand-gripping surface 38, on that side of the movement plane 50 which is directed away from a roadway.

In particular in the case of a hydraulic actuation transmission unit, the actuating-lever housing 32 also comprises a housing portion 72 in which a reservoir 74 is provided, illustrated in FIGS. 1, 2 and 5, the housing portion 72 having an opening 76, illustrated in FIG. 3, which can be closed by a housing cover 80, it being possible for the housing cover 80 preferably to be screwed onto the housing portion 72.

An adjusting-lever housing 82, which comprises a basic housing body 84 and a housing cover 86, illustrated in FIG. 2, is formed integrally on the housing cover 80.

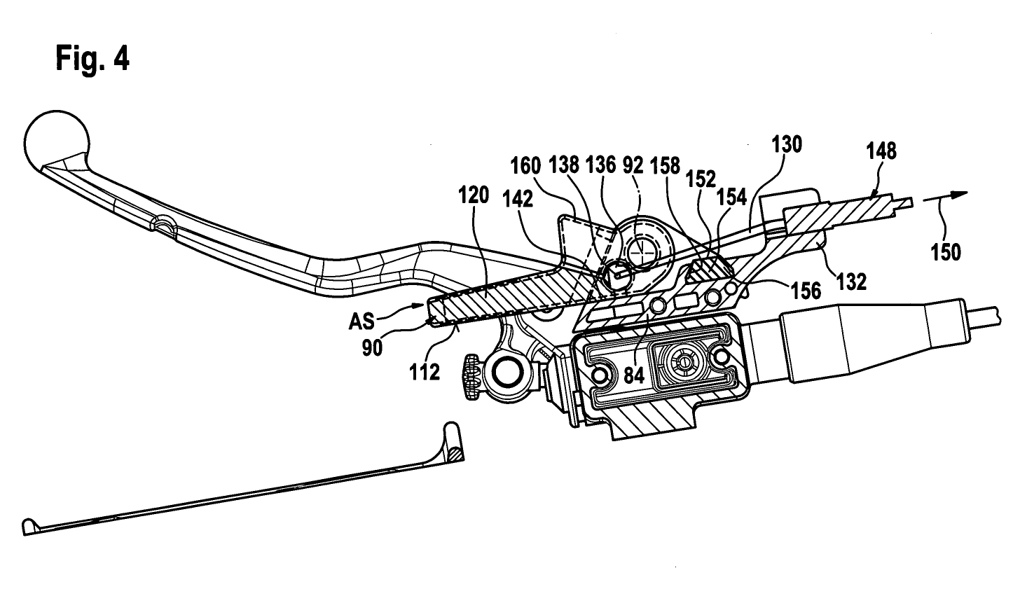

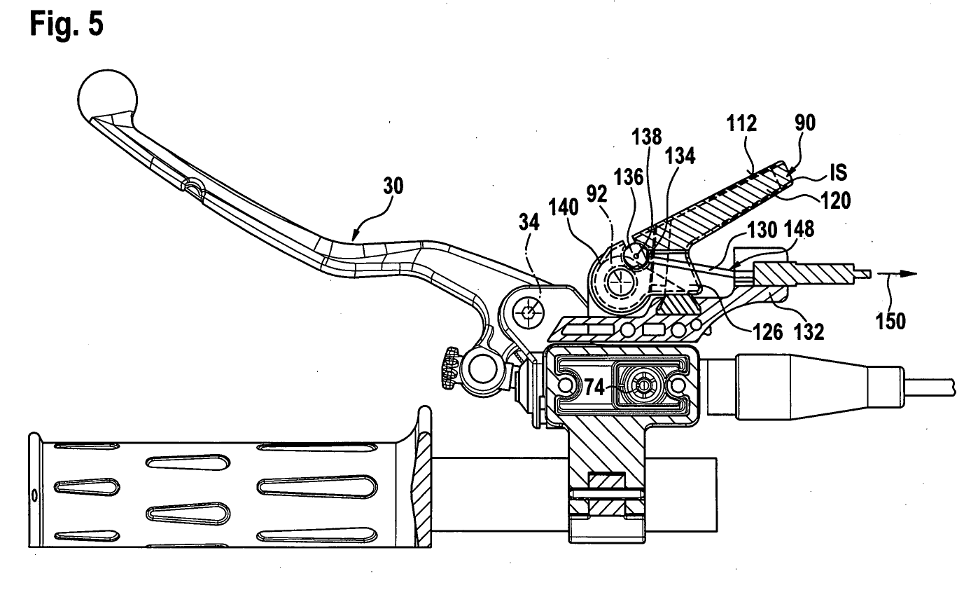

An adjusting lever, which is designated as a whole by 90, is mounted in the adjusting-lever housing 82 such that it can be pivoted about a pivot axis 92, to be precise such that the adjusting lever 90 can be moved from an active position AS, which is illustrated in FIGS. 1 and 4 and in which the pivot lever 90 is positioned on that side of the pivot axis 92 which is directed toward the actuating lever 30, into an inactive position IS, which is illustrated in FIG. 5 and in which the adjusting lever 90 is positioned on that side of the pivot axis 92 which is directed away from the actuating lever 30.

As is illustrated in FIG. 2, the pivot lever 90 here can be moved, between the active position AS and the inactive position IS, in a pivoting plane 100 which is inclined by an angle α in relation to the movement plane 50, the angle α being less than 30°, even better less than 20°, and preferably less than 15°. Furthermore, the pivoting plane 100 is located on that side of the movement plane 50 on which a user can likewise substantially position his or her hand 70 on the handle 16 and the actuating lever 30 in order to move the actuating lever 30 relative to the handle 16 from the non-actuated position SU into the actuated position SB, both positions being illustrated in FIG. 1.

According to the invention, the adjusting lever 90 is mounted in the adjusting-lever housing 82 such that in its active position AS, which is illustrated in FIGS. 1 and 4, the adjusting lever is located substantially on that side of a plane 102 which is directed away from the handle 16 and the actuating portion 40 of the actuating lever 30, this plane running perpendicularly to the center axis 20 and intersecting the inner annular body 24 of the handle 16.

The adjusting lever 90 is thus also located outside a manual-action region 104 in which the hand 70 extends as it acts on the hand-gripping surface 38 of the actuating lever 30 using the fingers, with the exception of the thumb, substantially using the index finger, middle finger and ring finger (see FIG. 1).

However, in its active position AS, which is illustrated in FIGS. 1 and 4, the adjusting lever 90 extends with its longitudinal direction 110 approximately parallel to the center axis 20 of the handle 16, and it has a finger-actuating surface 112 which, in the active position AS, is directed substantially toward the handle 16, but at a distance from the hand-resting surface 18 of the handle 16.

In its active position AS, which is illustrated in FIGS. 1 and 4, the adjusting lever 90 preferably extends in a region between the end region 14 of the handlebar 12 and the actuating lever when this is in its non-actuated position SU, preferably in the vicinity of the bearing portion 46 of the actuating lever 30, so that, when the fingers of the hand are resting on the hand-gripping surface 38 of the actuating lever 30, in particular when the index finger, middle finger and ring finger are resting on the hand-actuating surface 38, the finger-actuating surface 112, which is directed toward the handle 16, can be acted on by means of the thumb in order to effect a pivoting movement of the adjusting lever 90, during which the latter pivots about the pivot axis 92 from the active position AS into the inactive position IS and, in the process, the finger-actuating surface 112 moves increasingly away from the end region 14 of the handlebar 12.

As is illustrated in FIGS. 3 to 6, the adjusting lever 90 comprises an outer lever arm 120 which carries the finger-actuating surface 112 and merges into two spaced-apart lever side pieces 122, 124, between which an interspace 126 remains, this interspace also extending beyond the pivot axis 92.

Running within the interspace 126 is a pulling element 130 which, starting from a guiding holder 132 on the adjusting-lever housing 82, extends into the interspace 126 as far as an anchoring body 136 which is mounted in an articulated manner in a bore 134 of the adjusting lever 90 and, by way of its pivot axis, forms a point of articulation 138 for the pulling element 130, it being possible for this point of articulation, as the adjusting lever 90 pivots from the inactive position IS into the active position AS and vice versa, to be moved over an arcuate segment 140 about the pivot axis 92 of the adjusting lever 90, it being the case that in the active position AS of the adjusting lever 90, for example illustrated in FIG. 4, the point of articulation 138, in relation to the path taken by the pulling element 130 between the point of articulation 138 and the guiding holder 132, is in a so-called over-dead-center position, in which a pulling action to which the point of articulation 138 is subjected by the pulling element 130 keeps the adjusting lever 90, in the active position, in abutment against a housing stop 142, formed by the basic housing body 84, and prevents the adjusting lever 90 from moving automatically from the active position, illustrated in FIGS. 1 and 4, into the inactive position, illustrated in FIG. 5.

The pulling element 130 is part of a transmission device 148 which transmits the position of the adjusting lever 90 in order to adjust a function of the handlebar-steered vehicle, in particular a driving function of the handlebar-steered vehicle.

For example, the adjusting lever 90 can be used to actuate a so-called parking brake of the vehicle, the parking brake being effective in the active position of the adjusting lever 90 and being released in the inactive position of the latter.

The parking brake always subjects the adjusting lever 90, by way of the transmission device 148, to a retraction force 150, as a result of which, as the adjusting lever moves out of the active position AS, substantially all that is required when the finger-actuating surface 112 is acted on using the thumb is for a dead-center position of the pulling element 130, which extends between the point of articulation 138 and the guiding holder 132, to be reached and, once the dead-center position has been exceeded, the pulling force 150 of the pulling element 130 results in the adjusting lever 90 moving automatically, without any manual intervention, into the inactive position IS.

Since the adjusting lever 90 undergoes very pronounced acceleration as it moves into the inactive position IS, an elastic body 154 is provided as housing stop 152, this latter defining the inactive position IS, the elastic body having a dovetail-like foot region 156 which, for its part, is retained in a dovetail-like holder 158 in the basic housing body 84, it being possible for the basic housing body 84, and thus also the holder 158 with the elastic body 154 inserted therein, to be closed by the housing cover 86. In the inactive position IS, the adjusting lever 90 can be positioned against the housing stop 152 by way of a stop nose 160.

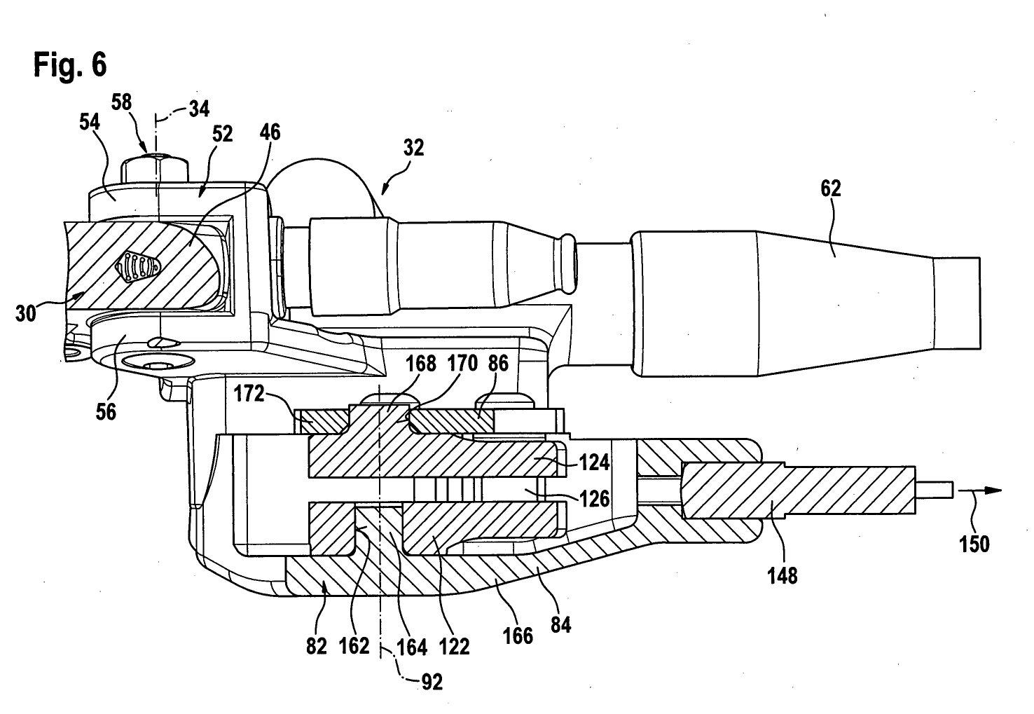

In order for it to be possible to move the pulling element 130 in the interspace 126 across the pivot axis 92 in order to reach the over-dead-center position, the lever side piece 122, as is illustrated in FIGS. 3 and 6, is provided with a bore 162, in which engages a bearing pin 164 which is integrally formed on the basic housing body 84 and is disposed coaxially in relation to the pivot axis 92, so that the lever side piece 122 is mounted on a side wall 166 of the basic housing body 84 of the adjusting-lever housing 82 in a state in which it is coaxial in relation to the pivot axis 92.

Furthermore, the lever side piece 124, for its part, is provided with a bearing pin 168, which engages in a bore 170 in the housing cover 86 and is thus mounted on the housing cover 86, which forms a side wall 172, such that it can be pivoted likewise coaxially in relation to the pivot axis 92 (see FIG. 6).

1. Lever arrangement for handlebar-steered vehicles, comprising an actuating-lever housing which can be fitted to a handlebar, adjoining a handle, by way of a mounting portion and on which an actuating lever is mounted such that it can be pivoted about an axis, and also comprising an adjusting lever which can be moved, by pivoting about a pivot axis, from a stable inactive position, in which the adjusting lever is positioned on that side of its pivot axis which is directed away from the actuating lever, into a stable active position, in which the adjusting lever is positioned on that side of its pivot axis which is directed toward the actuating lever, and vice versa,
the adjusting lever being mounted in a pivotable manner in an adjusting-lever housing disposed on the actuating-lever housing, and the adjusting lever, in the active position, having a finger-actuating surface which is at a distance from the handle and is directed toward the latter and, when this finger-actuating surface is acted on, the adjusting lever executes a pivoting movement leading away from the handle and out of the active position.

2. Lever arrangement according to claim 1, wherein the adjusting lever, in the active position, is located outside a manual-action region for actuating the actuating lever, this region extending between a hand-resting surface of the handle and a hand-gripping surface of the actuating lever.

3. Lever arrangement according to claim 1, wherein the adjusting lever, in its active position, has its finger-actuating surface disposed such that, when the fingers of one hand are engaged on the hand-gripping surface, this finger-actuating surface can be acted on by the thumb of the same hand.

4. Lever arrangement according to claim 3, wherein the adjusting lever, in the active position, has its finger-actuating surface located alongside the hand-gripping surface of the actuating lever, in a state in which it is offset in the direction of the actuating-lever housing.

5. Lever arrangement according to claim 3, wherein the adjusting lever, in its active position, has its finger-actuating surface located between the hand-gripping surface of the actuating lever and the actuating-lever housing.

6. Lever arrangement according to claim 1, wherein the finger-actuating surface of the adjusting lever, in the active position, is located on that side of a movement plane of the actuating lever on which a hand which is acting on the actuating lever is located.

7. Lever arrangement for handlebar-steered vehicles, comprising an actuating-lever housing which can be fitted to a handlebar, adjoining a handle, by way of a mounting portion and on which an actuating lever is mounted such that it can be pivoted about an axis, and also comprising an adjusting lever which can be moved, by pivoting about a pivot axis, from a stable inactive position, in which the adjusting lever is positioned on that side of its pivot axis which is directed away from the actuating lever, into a stable active position, in which the adjusting lever is positioned on that side of its pivot axis which is directed toward the actuating lever, and vice versa, the adjusting lever being adapted to be moved in a pivoting plane which runs at an angle of less than 30° in relation to the movement plane of the actuating lever.

8. Lever arrangement according to claim 1, wherein the actuating-lever housing has a cover, on which the adjusting-lever housing is disposed.

9. Lever arrangement according to claim 8, wherein the adjusting-lever housing is formed integrally on the cover.

10. Lever arrangement according to claim 8, wherein the cover of the actuating-lever housing covers a hydraulic reservoir provided therein.

11. Lever arrangement according to claim 1, wherein the adjusting lever acts on a transmission device which is biased elastically in a retraction direction.

12. Lever arrangement according to claim 11, wherein the transmission device acts on the adjusting lever such that the latter passes automatically into the inactive position after moving out of the active position.

13. Lever arrangement according to claim 12, wherein the adjusting lever, in the active position, is in an over-dead-center position.

14. Lever arrangement according to claim 13, wherein by means of the adjusting lever, an articulation of a pulling element of the transmission device can be moved over an arcuate segment about the pivot axis.

15. Lever arrangement according to claim 14, wherein the adjusting lever has two lever side pieces disposed on both sides of an interspace, and in that the pulling element, leading away from the articulation, runs within the interspace.

16. Lever arrangement according to claim 15, wherein the two lever side pieces are disposed between side walls of the adjusting-lever housing.

17. Lever arrangement according to claim 16, wherein each lever side piece, on its side which is directed away from the interspace, is mounted in a pivotable manner on the respective side wall of the adjusting-lever housing.

18. Lever arrangement according to claim 1, wherein a damping element is associated with the inactive position of the adjusting lever.

19. Operating unit for a vehicle steered by a handlebar having at least one handle, and a lever arrangement associated with the handle, said lever arrangement comprising an actuating-lever housing which can be fitted to a handlebar, adjoining a handle, by way of a mounting portion and on which an actuating lever is mounted such that it can be pivoted about an axis, and also comprising an adjusting lever which can be moved, by pivoting about a pivot axis, from a stable inactive position, in which the adjusting lever is positioned on that side of its pivot axis which is directed away from the actuating lever, into a stable active position, in which the adjusting lever is positioned on that side of its pivot axis which is directed toward the actuating lever, and vice versa, the adjusting lever being mounted in a pivotable manner in an adjusting-lever housing disposed on the actuating-lever housing, and the adjusting lever, in the active position, having a finger-actuating surface which is at a distance from the handle and is directed toward the latter and, when this finger-actuating surface is acted on, the adjusting lever executes a pivoting movement leading away from the handle and out of the active position.
